(19) United States
(12) Patent Application Publication
(10) Pub. No.: US 2014/0370469 A1
(43) Pub. Date: Dec. 18, 2014

(54) UTILIZING APPLIANCE OPERATING PATTERNS TO DETECT COGNITIVE IMPAIRMENT

(71) Applicant: International Business Machines Corporation, Armonk, NY (US)

(72) Inventors: Paul N. Krystek, Highland, NY (US); Mark B. Stevens, Austin, TX (US); John D. Wilson, Houston, TX (US)

(21) Appl. No.: 13/916,062

(22) Filed: Jun. 12, 2013

(51) Int. Cl. G09B 5/00

(52) U.S. Cl. CPC G09B 5/00
USPC 434/236

(57) ABSTRACT

A method, system or computer usable program product for detecting a change in appliance operating patterns as an indication of cognitive impairment including monitoring a first operating pattern for an appliance by a user to establish a baseline operating pattern; and responsive to detecting a second operating pattern for the appliance by the user deviating from the established baseline operating pattern exceeding a threshold, providing an indication of a possible cognitive impairment of the user.

### BACKGROUND

1. Technical Field

The present invention relates generally to utilizing appliance operating patterns to detect cognitive impairment, and in particular, to a computer implemented method for detecting a change in appliance operating patterns as an indication of cognitive impairment of the user.

2. Description of Related Art

There are many types of cognitive impairment that can affect the reaction time, memory, thinking, judgment or the ability to perform complex tasks. Cognitive impairment can develop slowly over many years such as with several types of chronic or degenerative dementia (e.g., Alzheimer's disease) or with other forms of cognitive decline. Cognitive impairment can also have acute onset due to head trauma or other disease conditions. In either case the patient or other interested persons such as a physician may not recognize the initial symptoms or may not appreciate the degree of impairment.

Early recognition of cognitive impairment is important for the treatment before additional damage may occur, some of which may be irreversible. Depending on the type of cognitive impairment, such treatment may be to reduce the rate of decline or to treat the underlying cause and reverse the cognitive impairment.

### SUMMARY

The illustrative embodiments provide a method, system, and computer usable program product for detecting a change in appliance operating patterns as an indication of cognitive impairment including monitoring a first operating pattern for an appliance by a user to establish a baseline operating pattern; and responsive to detecting a second operating pattern for the appliance by the user deviating from the established baseline operating pattern exceeding a threshold, providing an indication of a possible cognitive impairment of the user.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a set of appliances and sensors coupled to a network in which various embodiments may be implemented;

FIG. 4 is a flow diagram of the operation of an appliance in which various embodiments may be implemented;

FIG. 5 is a flow diagram of analyzing appliance activities for operating patterns indicating cognitive impairment in accordance with a first embodiment;

FIG. 6 is a flow diagram of analyzing appliance activities for operating patterns indicating cognitive impairment in accordance with a second embodiment; and

FIGS. 7A-7B are block diagrams of data structures utilized for storing appliance capabilities and activities for statistical analysis in which various embodiments may be implemented.

### DETAILED DESCRIPTION

Processes and devices may be implemented and utilized for detecting a change in appliance operating patterns as an indication of cognitive impairment of the user. These processes and apparatuses may be implemented and utilized as will be explained with reference to the various embodiments below.

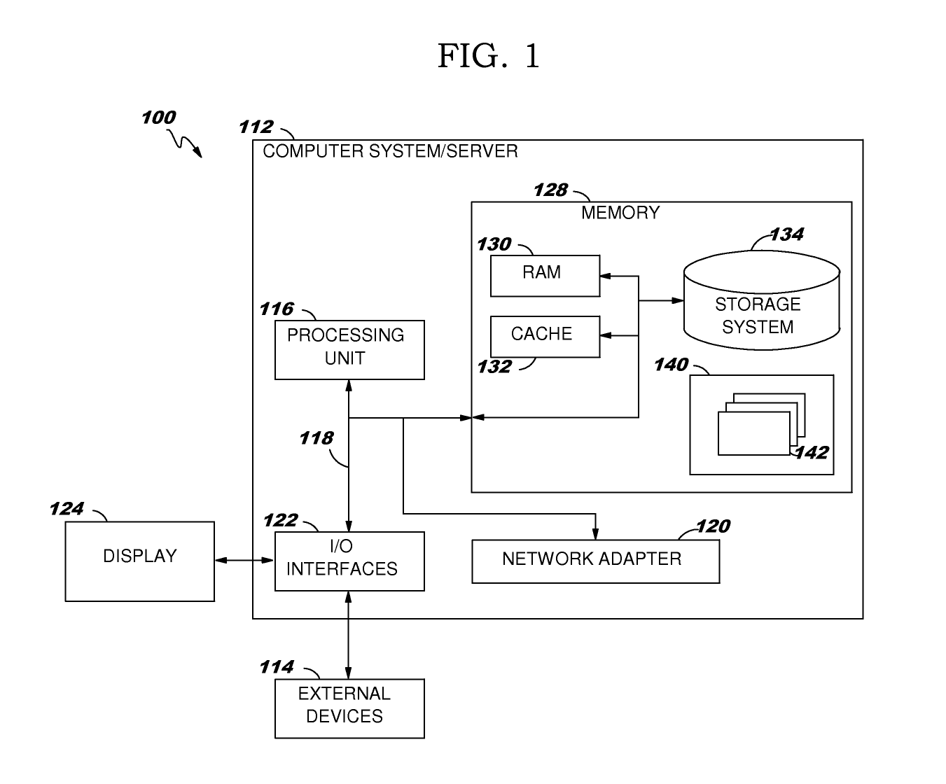

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as detecting a change in appliance operating patterns as an indication of cognitive impairment of the user.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of computer system readable media. Such media may be any available media that is accessible by computer system/server 112, and it includes both volatile and non-volatile media, removable and non-removable media.

System memory 128 can include computer system readable media in the form of volatile memory, such as random access memory (RAM) 130 and/or cache memory 132. Computer system/server 112 may further include other removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for detecting a change in appliance operating patterns as an indication of cognitive impairment of the user.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

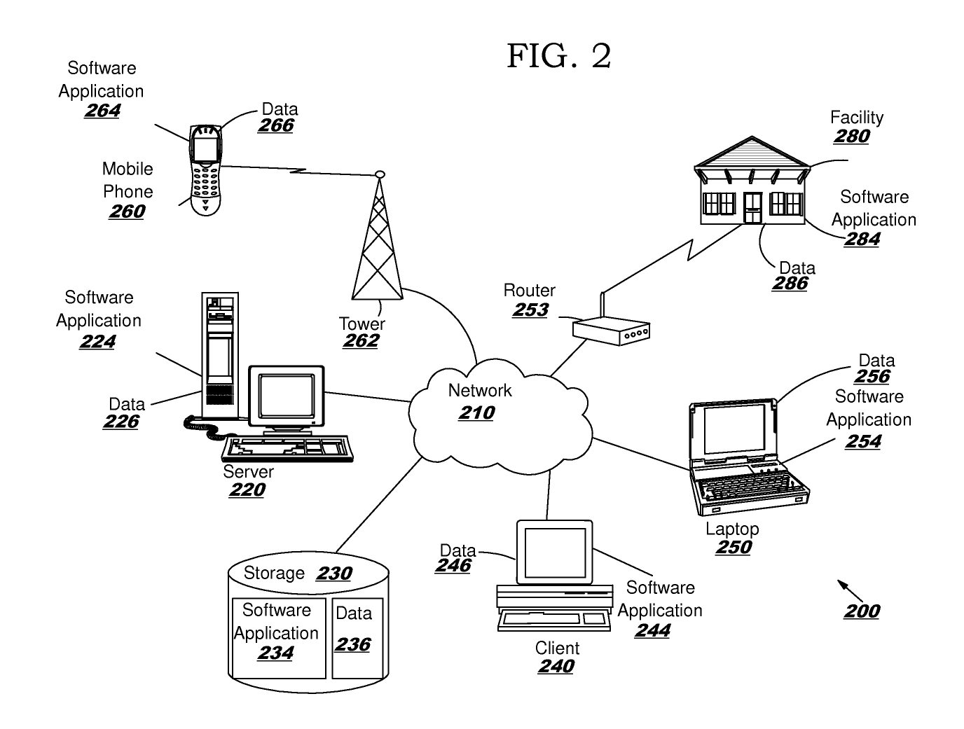

FIG. 2 is a block diagram of an illustrative network of data processing systems in which various embodiments of the present disclosure may be implemented. Data processing environment 200 is a network of data processing systems such as described above with reference to FIG. 1. Software applications, such as for detecting a change in appliance operating patterns as an indication of cognitive impairment of the user, may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250 and facility 280 (such as a home or business) are coupled to network 210 including wirelessly such as through a network router 253. A mobile phone 260 may be coupled to network 210 through a mobile phone tower 262. Data processing systems, such as server 220, client 240, laptop 250, mobile phone 260 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for detecting a change in appliance operating patterns as an indication of cognitive impairment of the user or other software applications and data in accordance with embodiments described herein. Storage 230 may contain software application 234 and a content source such as data 236 for detecting a change in appliance operating patterns as an indication of cognitive impairment of the user. Other software and content may be stored on storage 230 for sharing among various computer or other data processing devices. Client 240 may include software application 244 and data 246. Laptop 250 and mobile phone 260 may also include software applications 254 and 264 and data 256 and 266. Facility 280 may include software applications 284 and data 286. Other types of data processing systems coupled to network 210 may also include software applications. Software applications could include a web browser, email, or other software application for detecting a change in appliance operating patterns as an indication of cognitive impairment of the user.

Server 220, storage unit 230, client 240, laptop 250, mobile phone 260, and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

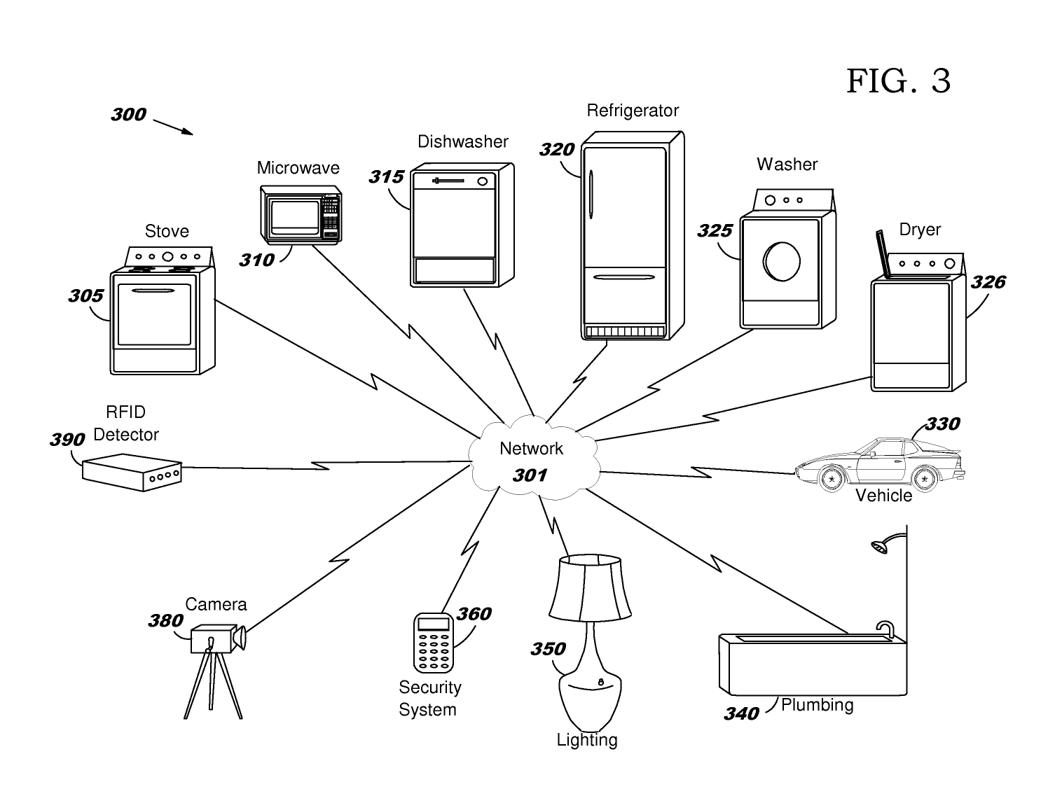

FIG. 3 is a block diagram of a set of appliances and sensors 300 coupled to a network 301 in which various embodiments may be implemented. These appliances and sensors may be located at a facility as shown in FIG. 2 such as in a residence, business or commercial setting. Each appliance may be a smart appliance with software, processing and communications capabilities.

Various appliances may be utilized in a kitchen such as a stove 305, a microwave 310, a dishwasher 315, a refrigerator 320, and a clothes washer 325 and dryer 326. Other kitchen appliances may be utilized as well such as a toaster, blender, etc. A vehicle 330 may also be included as an appliance and may be coupled to network 301 continuously through a cellular or other mobile connection or periodically when parked at the facility. Facility plumbing 340 such as bathtub and shower facilities, sink facilities, etc. may be utilized. Lighting 350 such as lamps, overhead lights may also be utilized. A security system 360 may be utilized. Many other types of appliances may be included including various entertainment systems. Appliances are typically single function devices such as for washing clothes, cooking food, etc. and may be more specifically referred to as single function appliances. Appliances also typically have mechanical functions for performing the main function of the device (e.g., drying clothes, providing water) mixed with electrical capabilities and may be more specifically referred to as mechanical appliances.

Also shown is a video camera 380 and a RFID detector 390 which are also coupled to network 301. These sensors and other sensors may be utilized for determining the person utilizing the appliances throughout the facility. This determination can be made using facial recognition, size and shape comparisons, voice recognition, detected RFID tags which may be worn by each resident, etc. Additional sensors may be included in each appliance such as a fingerprint detector, microphone or an additional camera. Also, the user may be identified through keypad or voice entry of a password or other identifying data entry by the user.

Each of these appliances is connected to the network 301 directly or indirectly. The connection may be Wi-Fi, Bluetooth, or other wireless connection or they may be directly wired to the network such as through a cable connection. Each appliance has some capability to communicate through the network and receive user instructions or provide information regarding user activities as described below. For example, plumbing 340 may include sensors to identify the user drawing a bath and to determine when the user has overflowed the tub. Plumbing 340 is also connected to the network to sharing that information with a central processing unit which may be local or remote such as across the internet.

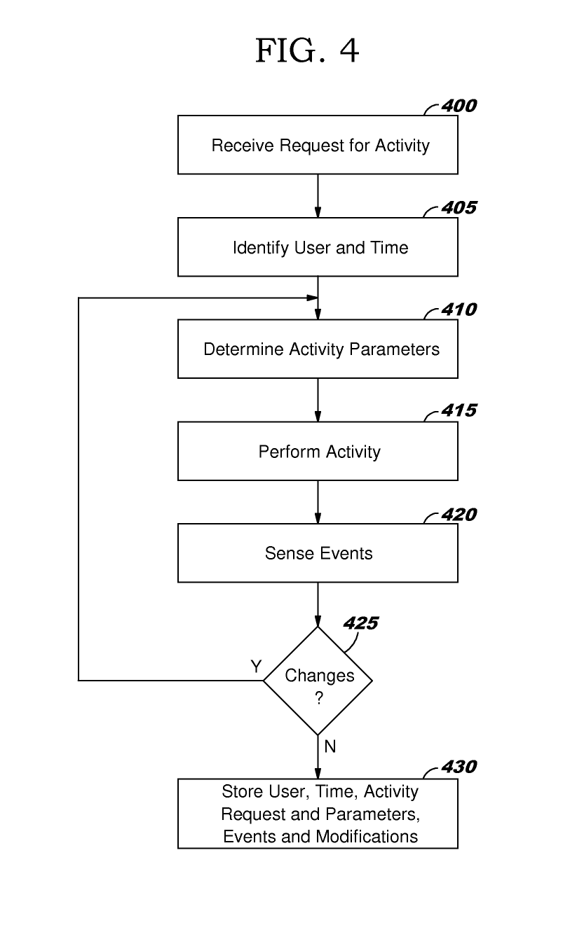

FIG. 4 is a flow diagram of the operation of an appliance in which various embodiments may be implemented. The appliance may any one of the appliances shown in FIG. 3 or other appliances not shown. In a first step 400, the appliance receives a request from a user to perform an activity. This can be a single button pressed by the user to perform an activity such as a button for a dishwasher to perform a standard wash cycle, or it may be a keypad or voice entry of a variety of information such as the amount of time, temperature and type of heat (broil, bake, etc.) for an oven. The request may also be received remotely from a mobile phone or other data processing system such as a work computer.

In a second step 405 the user entering the request is identified and the time determined. The user may be identified by the appliance such as through fingerprint identification, keypad entry of a userid or password, voice recognition with a microphone, facial recognition with a camera, etc. Alternatively, the use may be identified by a central unit accessing a camera, microphone or other sensor in the area of the appliance. If accomplished by a central unit, the identity may be shared with the appliance. The time can include the time of day as well as the date. Subsequently in step 410, the appliance determines the parameters for the desired activity. For example, if the user pushes a button to request a standard wash cycle, then the parameters for a standard wash cycle are obtained from memory. Alternatively, the user may be queried for the activity parameters. Once the activity parameters are obtained, then in step 415 the requested activity is performed in accordance with the parameters.

As the requested activity is performed, sensors may identify events or not in step 420 such as food burning or overcooking, water overflowing or boiling over, etc. As a result, in step 425 a determination is made whether certain activity parameters should be changed or otherwise modified. For example, the heat of a stove burner may need to be reduced or turned off. If yes in step 425, then processing returns to step 410, otherwise processing continues to step 430.

Finally, in step 430, the identified user, the time of the requested activity, the requested activity and activity parameters, and any events or activity parameter modifications for statistical analysis. Various types of parameters, events or other data may be tracked including completion time, a required utensil, a complexity, a safety metric, a breadth, a depth, a variety, a content, a reduction, an omission, a scope, etc. This information may be stored in memory of the appliance or stored remotely at a central unit. Such a central unit may be a computer located in the facility or a server or storage unit located remotely across the internet.

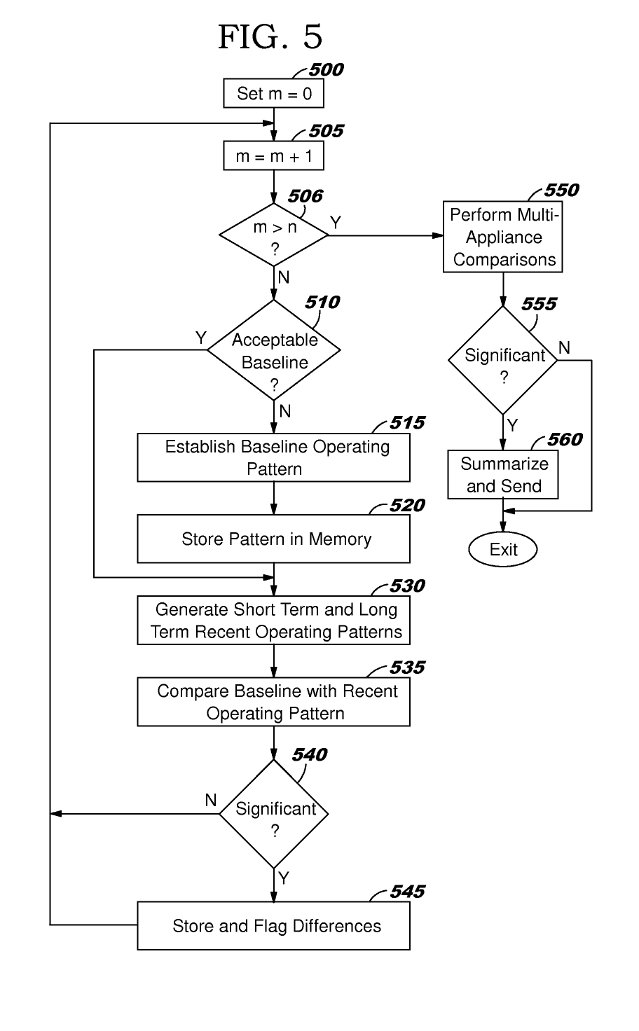

FIG. 5 is a flow diagram of analyzing appliance activities for operating patterns indicating cognitive impairment in accordance with a first embodiment. Each appliance may have a baseline operating pattern established which is then compared to recent operating patterns to determine whether a change has occurred indicating cognitive impairment. The foregoing assumes a single user, but may easily be modified for several users as described below. The foregoing may be performed by a central processing unit with activity information from each appliance. Alternatively, the foregoing may be performed by each appliance individually with the results forwarded to a central processing unit.

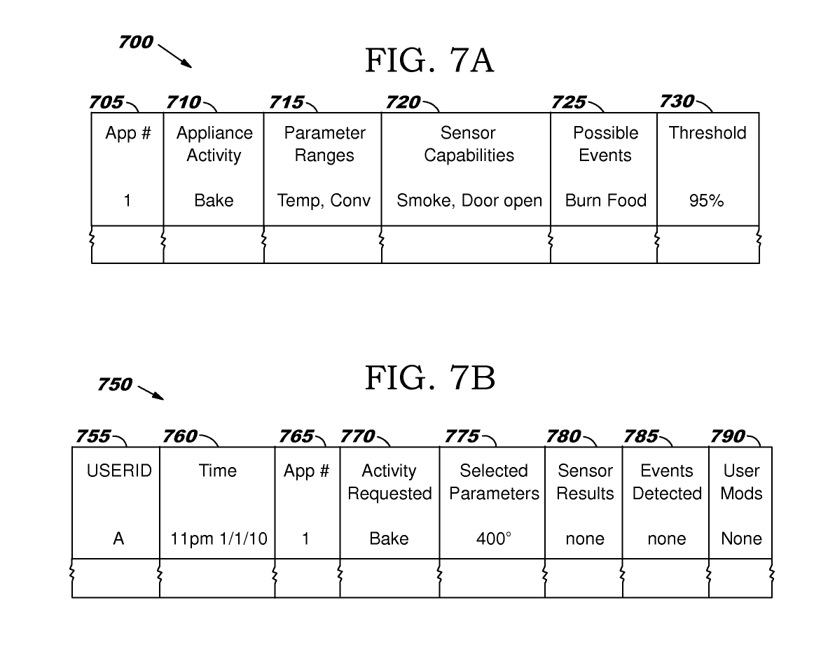

In a first step 500 a counting variable m is set to 0. This variable is utilized to count through the number of appliances n being tracked for operating pattern changes. For example, if the operating patterns of three different appliances are being tracked for a given user, then n will be equal to 3 and there will be three entries in a database for that user as shown in FIG. 7 below. In a second step 505, counting variable m is incremented by 1. In a third step 506, it is determined whether M is greater than n. If yes, then processing continues to step 550, otherwise processing continues to step 510.

In step 510, it is determined whether a previous baseline was established for appliance m and whether that baseline is acceptable for current use. The baseline pattern is a statistical pattern established by the user for a given period of time or number of uses of the appliance. For example, the pattern may be established over 3 months or the first 100 uses of the appliance by the user. The amount of time or number of uses utilized to establish a baseline pattern may differ based on the type of appliance. The baseline pattern may be recomputed periodically to include more time or uses the longer the period of tracking increases. That is, a baseline may have been previously established but may need a periodic update. If yes in step 510, the current baseline is acceptable, then processing continues to step 530 below otherwise processing continues to step 515.

In step 515, a baseline operating pattern is established for appliance m. For example, if m is equal to 1 and the first appliance is an oven, then a baseline pattern is established for the oven. In the case of an oven, the pattern can include time of day for cooking, temperature used, duration of cooking at that temperature, the number of times the door is opened during cooking, whether any food was burned, the length of time to open the oven door after the cooking was completed and a signal provided to the user, etc. This pattern can include an average and a standard deviation or other measure of dispersion. This baseline may also be expressed as a similarity or difference from average patterns for a population of users. For example, the user may more frequently open the door during cooking than the average user. This allows anyone reviewing the resulting data below to better understand the operating patterns of the user within a greater context. Once a baseline is established, that baseline is stored in memory in step 520 for present or future use.

Subsequently in step 530, a short term recent operating pattern and a long term recent operating pattern are generated from the historical data. The short term recent operating pattern includes fewer uses of an appliance over a shorter period of time (e.g., 48 hours) and is utilized to detect acute recent cognitive impairment whereas the long term recent operating pattern includes more uses of an appliance over a longer period of time (e.g., one month) and is utilized to detect chronic or degenerative cognitive impairment. The short terms and long term recent operating patterns are determined similar to the baseline operating pattern to provide consistent pattern types suitable for statistical analysis.

Processing then continues to step 535 where the baseline operating pattern is compared to the short term recent operating pattern and the long term recent operating pattern to look for significant negative pattern differences. That is, positive pattern differences may be ignored in some circumstances. For example, if the user burns food much less often or opens an oven door after a signal is provided much more quickly than normal, then those pattern differences may be ignored. Various types of parameters, events or other trackable data may be compared including completion time, a required utensil, a complexity, a safety metric, a breadth, a depth, a variety, a content, a reduction, an omission, a scope, etc. In step 540, it is determined whether these negative pattern differences are statistically significant or otherwise exceeded a preset threshold. For example, a health care provider or other responsible party can set a threshold of a statistical confidence percentage (e.g., 95% confident), a statistical variation to be exceeded (e.g., 5 sigma), a simple absolute threshold (e.g., burn foods three times within a week), or other predetermined threshold. The threshold may be preset for each appliance or for each user across all appliances. If not significant, then processing returns to step 505 above, otherwise processing continues to step 545 where the pattern differences are stored and flagged for processing as described below and processing returns to step 505 above.

Step 550 is performed after all the appliances have been reviewed individually for significant pattern differences (i.e. yes in step 506). In step 550, certain multi-appliances comparisons are performed. For example, when preparing a meal, there is a pattern of using the refrigerator to prepare items for cooking, cooking the food, then washing the pots, pans and dishes in the dishwasher. Changes to this pattern may indicate a loss of organizational skills (e.g., keep going to the refrigerator during cooking to obtain a missing item) and resulting cognitive decline. Subsequently in step 555 it is determined whether there were any significant multi-appliance operating pattern observed or if any of the appliances have flagged significant negative short term or long term pattern differences. If not, then processing ends for this user, otherwise processing continues to step 560. In step 560, the significant pattern differences are summarized and provided to a predesignated person or persons. This could be in the form of an alert, a notification, an email, a text message, or a report sent to a health care professional, a caregiver or a family member. For example, this could be in a text or email to a mobile phone of a family member, to a server of a responsible physician, etc. The communication may be in summary form only or may include the details of the pattern differences. The person receiving the communication can also later download the stored and flagged pattern differences as well as other detailed information to perform additional analysis. The fact that significant pattern differences may have occurred is not diagnostic in and of itself, but is a tool to allow others such as medical professionals to utilize the information in performing further testing and diagnostic analysis of possible cognitive impairment, whether acute or longer term. Processing then ceases for this user, although the above described process is repeated for each user of the appliances.

Each type of appliance can have a different set of activities, activity parameters, sensing capabilities, and operating patterns which can be captured and utilized to identify possible cognitive impairment. With smart appliances, these elements may be updated periodically by the manufacturer, seller or maintenance entity for each appliance. Furthermore, additional pattern recognition capabilities may be introduced based on recommendations of a health care professional or as research better identifies parameters useful for detecting cognitive impairment.

Many types of parameters, events, sensor results, and user modifications can be identified and captured for pattern analysis. This information may be collected by the appliances directly or through other sensors within or outside the facility. Some examples of information gathering by appliance are provided below. One of ordinary skill may generate many other possible patterns to observe utilizing these and other appliances.

For example, with a stove and microwave, the activity selected, the time and temperature selected or modified for that activity, the number of times the door is opened before the activity is completed, the length of time to open the door after the activity is completed, the number of additional activities without opening the door, etc. may be captured for analysis. With a dishwasher, the activities selected, whether the door was opened before the activity was completed, whether the dishes were pre-cleaned or not, whether the dishwasher was poorly loaded, delayed unloading, etc. may be captured for analysis. With a refrigerator, the number of door openings per day or other time period, door openings at unusual times, the door being left open for extended periods of time, the amount of contents of the refrigerator, etc. may all provide possible indications of cognitive decline such as a loss of interest in food, less complex meals, forgetfulness or other possible cognitive issues. With a washer and dryer, unusual loading patterns (colors and load sizes), changes in washing patterns such as not utilizing permanent press setting, delayed unloading, increased time between washings, and other may also indicate possible cognitive decline over time.

With a vehicle such as a car, slow driving, running out of gas, putting the transmission in a gear other than drive and then driving at high speed, leaving the blinker on excessively, accidents, and many other events may be useful for analysis. With plumbing, general water operating patterns, not using the bathtub or shower for extended periods, overflows, filling a bathtub with all hot water, running the sink facet for extended periods of time or not fully turning off the facet between uses, etc. may also be indicators. For general electrical and lighting, significant decreased operation or leaving things on for excessive periods of time, unusual heating and cooling requirements, burnt out light bulbs not replaced, localization of activities to a single room, etc. may also be possible indicators. For a security system, a reduction in use, key pad errors such as incorrect password entry, doors or windows atypically open, smoke alarm events, false alarms, motion detectors tracking atypical patterns such an aimless wandering, etc. For an entertainment system, tracking multiple replays of the same show or portion of a show, reduced use of television, television on for extended periods, reduction of channel scope, reduction of content complexity (e.g., going from world news to lowbrow programs), increased channel hopping, increase number of episode aborts, etc.

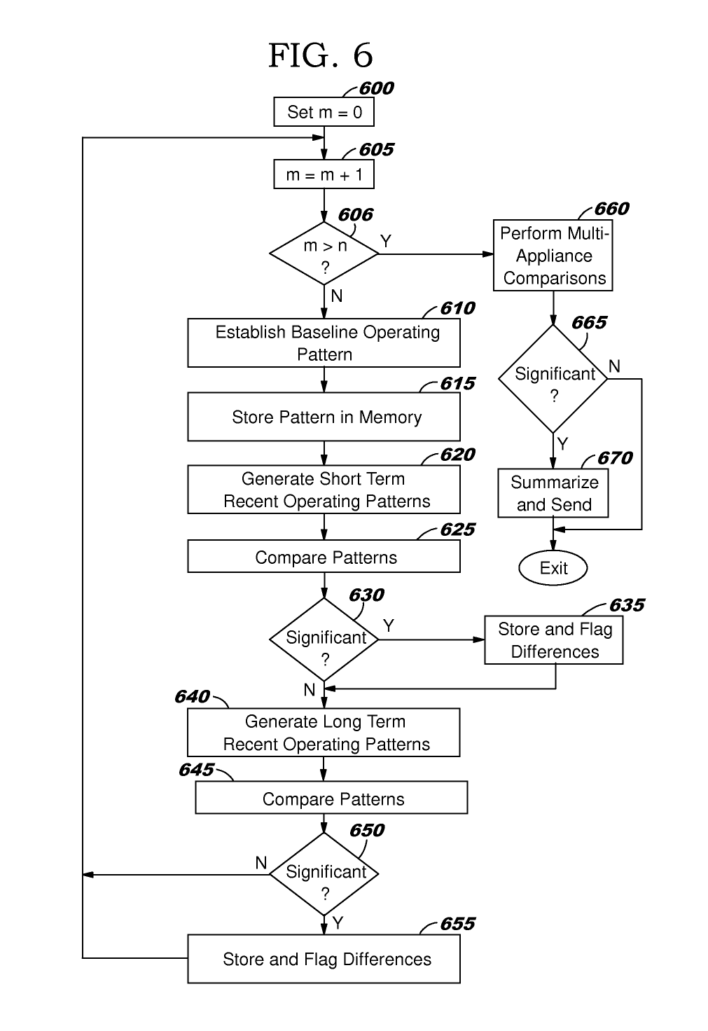

FIG. 6 is a flow diagram of analyzing appliance activities for operating patterns indicating cognitive impairment in accordance with a second embodiment. Each appliance may have a baseline operating pattern established which is then compared to recent operating patterns to determine whether a change has occurred indicating cognitive impairment. The foregoing assumes a single user, but may easily be modified for several users as described below. The foregoing may be performed by a central processing unit with activity information from each appliance. Alternatively, the foregoing may be performed by each appliance individually with the results forwarded to a central processing unit.

In a first step 600 a counting variable m is set to 0. This variable is utilized to count through the number of appliances n being tracked for operating pattern changes. For example, if the operating patterns of three different appliances are being tracked for a given user, then n will be equal to 3 and there will be three entries in a database for that user as shown in FIG. 7 below. In a second step 605, counting variable m is incremented by 1. In a third step 606, it is determined whether M is greater than n. If yes, then processing continues to step 660, otherwise processing continues to step 610.

In step 610, a baseline operating pattern is established for appliance m. This baseline includes all or substantially all historical operation data collected for that appliance. For example, if m is equal to 1 and the first appliance is an oven, then a baseline pattern is established for the oven. In the case of an oven, the pattern can include time of day for cooking, temperature used, duration of cooking at that temperature, the number of times the door is opened during cooking, whether any food was burned, the length of time to open the oven door after the cooking was completed and a signal provided to the user, etc. This baseline can include an average and a standard deviation or other measure of dispersion. This baseline may also be expressed as a similarity or difference from average patterns for a population of users. For example, the user may more frequently open the door during cooking than the average user. This allows anyone reviewing the resulting data below to better understand the operating patterns of the user within a greater context. Once a baseline is established, that baseline is stored in memory in step 615 for use and analysis. In alternative embodiments, the baseline may be stored in memory for future use, although the focus of this embodiment is to generate a new baseline each time this process is executed. This is to have as complete a history as practical incorporated into the baseline for more accurate detection capabilities.

Subsequently in step 620, a short term recent operating pattern is established. The short term recent operating pattern includes recent uses of an appliance over a short period of time (e.g., 48 hours) and is primarily utilized to detect acute recent cognitive impairment whereas a long term recent operating pattern includes more uses of an appliance over a longer period of time (e.g., one month) and is utilized to detect chronic or degenerative cognitive impairment. The short term operating pattern is determined similar to the baseline operating pattern to provide consistent pattern types suitable for statistical analysis.

Processing then continues to step 625 where the baseline operating pattern is compared to the short term recent operating pattern to identify significant negative pattern differences. That is, positive pattern differences may be ignored in some circumstances. For example, if the user burns food much less often or opens an oven door after a signal is provided much more quickly than normal, then those pattern differences may be ignored. Various types of parameters, events or other trackable data may be compared including completion time, a required utensil, a complexity, a safety metric, a breadth, a depth, a variety, a content, a reduction, an omission, a scope, etc. In step 630, it is determined whether these negative pattern differences are statistically significant or otherwise exceeded a preset threshold. For example, a health care provider or other responsible party can set a threshold of a statistical confidence percentage (e.g., 95% confident), a statistical variation to be exceeded (e.g., 5 sigma), a simple absolute threshold (e.g., burn foods three times within a week), or other predetermined threshold. The threshold may be preset for each appliance or for each user across all appliances. If not significant, then processing returns to step 640 below. Otherwise processing continues to step 635 where the pattern differences are stored and flagged for processing as described below and processing continues to step 640 below.

In step 640, recent long term operating patterns are derived from the baseline to identify whether any of the recent operating patterns indicate a negative change in user performance. For example, operating patterns for the past 30, 60 90, 180, 270 and 360 days may be derived from the long term baseline to determine whether there may be possible long term cognitive decline. Alternatively, these recent long term operating patterns may be independently generated from the underlying historical data. The various long term operating patterns are then compared to the overall baseline trends in step 645 to identify possibly long term cognitive decline. For example, the user may have shown a slow normal decline which then turns significantly worse for one or more of the recent long term operating patterns. For multiyear pattern analysis, this embodiment helps prevent false positives which may be caused by normal cognitive decline. This embodiment also includes all or nearly all historical data in the baseline for statistical analysis. Various types of parameters, events or other trackable data may be compared including completion time, a required utensil, a complexity, a safety metric, a breadth, a depth, a variety, a content, a reduction, an omission, a scope, etc. In step 650, it is determined whether these negative pattern differences are statistically significant or otherwise exceeded a preset threshold. For example, a health care provider or other responsible party can set a threshold of a statistical confidence percentage (e.g., 95% confident), a statistical variation to be exceeded (e.g., 5 sigma), a simple absolute threshold (e.g., burn foods three times within a week), or other predetermined threshold. The threshold may be preset for each appliance or for each user across all appliances. If not significant, then processing returns to step 605 above. Otherwise processing continues to step 655 where the pattern differences are stored and flagged for processing as described below and processing continues to step 605 above.

Step 660 is performed after all the appliances have been reviewed for significant pattern differences (i.e. yes in step 606). In step 660 certain multi-appliances comparisons are performed. For example, when preparing a meal, there is a pattern of using the refrigerator to prepare items for cooking, cooking the food, then washing the pots, pans and dishes in the dishwasher. Changes to this pattern may indicate a loss of organizational skills (e.g., keep going to the refrigerator during cooking to obtain a missing item) and resulting cognitive decline. Subsequently in step 665, it is determined whether any of the appliances have flagged significant negative short term or long term pattern differences. If not, then processing ends for this user, otherwise processing continues to step 670. In step 670, the significant pattern differences are summarized and provided to a predesignated person or persons. This could be in the form of an alert, a notification, an email, a text message, or a report sent to a health care professional, a caregiver or a family member. For example, this could be in a text or email to a mobile phone of a family member, to a server of a responsible physician, etc. The communication may be in summary form only or may include the details of the pattern differences. The person receiving the communication can also later download the stored and flagged pattern differences as well as other detailed information to perform additional analysis. The fact that significant pattern differences may have occurred is not diagnostic in and of itself, but is a tool to allow others such as medical professionals to utilize the information in performing further testing and diagnostic analysis of possible cognitive impairment, whether acute or longer term. Processing then ceases for this user, although the above described process is repeated for each user of the appliances.

Each type of appliance can have a different set of activities, activity parameters, sensing capabilities, and operating patterns which can be captured and utilized to identify possible cognitive impairment. With smart appliances, these elements may be updated periodically by the manufacturer, seller or maintenance entity for each appliance. Furthermore, additional pattern recognition capabilities may be introduced based on recommendations of a health care professional or as research better identifies parameters useful for detecting cognitive impairment. Examples of such types of activities for given appliances are described above.

Although the above two embodiments describe statistical analysis on an appliance by appliance basis, alternative embodiments may utilize statistical analysis across multiple appliances. For example, delays in opening the door of an appliance after the activity is completed may be analyzed across multiple appliances such as a washer, dryer, oven microwave, etc.

FIGS. 7A-7B are block diagrams of data structures utilized for storing appliance capabilities and activities for statistical analysis in which various embodiments may be implemented. FIG. 7A is directed to a data structure 700 listing appliances and their various capabilities. There are columns for each application number or ID 705, appliance activity 710, activity parameter ranges 715, sensor capabilities 720, possible events 725, and threshold 730. This data structure includes at least one entry for each appliance and standard appliance activity. For example, if an oven (appliance 1) has three standard activities (bake, broil and roast), then there would be three entries in data structure 700 for that appliance. Each activity has parameter ranges such as temperature, whether convection is turned on, etc. There are various sensor capabilities such as an internal smoke detector which can determine whether the food has burned (an event), and a sensor for determining when the oven door is opened after the complete cooking sound is provided. A threshold for determining significance is also provided, which is a 95% confidence of a statistically significant event in this example. In this example, the threshold is preset by appliance. Alternatively, the threshold may be preset by user. Alternative embodiments could utilize many alternative data structures and values to capture the same information in a readily accessible and usable layout.

FIG. 7B is directed to a historical database 750 for maintaining a listing of activities by the user(s) for a variety of appliances. There are columns for user ID 755, activity time 760 (including date and time), appliance number or ID 765, requested activity 770, selected parameters 775, sensor results 780, events detected 785, and user modifications 790. This data structure includes one entry for each appliance operation by a user. For example, if a user utilizes the security system and ends up incorrectly entering the security code twice, then that information is captured for future analysis.

The invention can take the form of an entirely software embodiment, or an embodiment containing both hardware and software elements. In a preferred embodiment, the embodiments are implemented in software or program code, which includes but is not limited to firmware, resident software, and microcode.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, microcode, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM), or Flash memory, an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for detecting a change in appliance operating patterns as an indication of cognitive impairment of the user. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of detecting a change in appliance operating patterns as an indication of cognitive impairment comprising:
monitoring a first operating pattern for an appliance by a user to establish a baseline operating pattern; and
responsive to detecting a second operating pattern for the appliance by the user deviating from the established baseline operating pattern exceeding a threshold, providing an indication of a possible cognitive impairment of the user.

2. The method of claim 1 wherein the baseline operating pattern is established prior to detecting a second operating pattern.

3. The method of claim 1 wherein the threshold is preset for the appliance.

4. The method of claim 1 wherein a plurality of appliances are monitored for establishing a baseline operating pattern and detecting a second operating pattern.

5. The method of claim 4 wherein detecting a second operating pattern deviating from a baseline operating pattern is for user operating patterns observed across multiple appliances.

6. The method of claim 1 wherein the second operating pattern differs from the first operating pattern by a completion time, a required utensil, a complexity, a safety metric, a breadth, a depth, a variety, a content, a reduction, an omission, and a scope.

7. The method of claim 1 wherein the appliance is selected from a group consisting of a stove, a microwave, a dishwasher, a refrigerator, a washer, a dryer, a vehicle, plumbing, lighting, a security system, and an entertainment system.

8. The method of claim 1 wherein the indication is transmitted to a predesignated person.

9. The method of claim 8 wherein the indication is selected from a group consisting of an alert, a notification, an email, a text message, and a report transmitted to a predesignated person selected from a group consisting of a health care professional, a caregiver and a family member.

10. The method of claim 5 wherein the baseline operating pattern is established prior to detecting a second operating pattern; wherein the second operating pattern differs from the first operating pattern by a completion time, a required utensil, a complexity, a safety metric, a breadth, a depth, a variety, a content, a reduction, an omission, and a scope; wherein the appliance is selected from a group consisting of a stove, a microwave, a dishwasher, a refrigerator, a washer, a dryer, a vehicle, plumbing, lighting, a security system, and an entertainment system; and wherein the indication is selected from a group consisting of an alert, a notification, an email, a text message, and a report transmitted to a predesignated person selected from a group consisting of a health care professional, a caregiver and a family member.

11. A computer usable program product comprising a computer usable storage medium including computer usable code for use in detecting a change in appliance operating patterns as an indication of cognitive impairment, the computer usable program product comprising code for performing the steps of:
monitoring a first operating pattern for an appliance by a user to establish a baseline operating pattern; and
responsive to detecting a second operating pattern for the appliance by the user deviating from the established baseline operating pattern exceeding a threshold, providing an indication of a possible cognitive impairment of the user.

12. The computer usable program product of claim 11 wherein the baseline operating pattern is established prior to detecting a second operating pattern.

13. The computer usable program product of claim 11 wherein the threshold is preset for the appliance.

14. The computer usable program product of claim 11 wherein a plurality of appliances are monitored for establishing a baseline operating pattern and detecting a second operating pattern.

15. The computer usable program product of claim 14 wherein detecting a second operating pattern deviating from a baseline operating pattern is for user operating patterns observed across multiple appliances.

16. A data processing system for detecting a change in appliance operating patterns as an indication of cognitive impairment, the data processing system comprising:
a processor; and
a memory storing program instructions which when executed by the processor execute the steps of:
monitoring a first operating pattern for an appliance by a user to establish a baseline operating pattern; and
responsive to detecting a second operating pattern for the appliance by the user deviating from the established baseline operating pattern exceeding a threshold, providing an indication of a possible cognitive impairment of the user.

17. The method of claim 16 wherein the baseline operating pattern is established prior to detecting a second operating pattern.

18. The method of claim 16 wherein the threshold is preset for the appliance.

19. The method of claim 16 wherein a plurality of appliances are monitored for establishing a baseline operating pattern and detecting a second operating pattern.

20. The method of claim 19 wherein detecting a second operating pattern deviating from a baseline operating pattern is for user operating patterns observed across multiple appliances.
